(19) United States
(12) Patent Application Publication
(10) Pub. No.: US 2016/0210185 A1
(43) Pub. Date: Jul. 21, 2016

(54) METHOD AND APPARATUS FOR WIRELESS COMMUNICATION

(71) Applicant: Samsung Electronics Co., Ltd., Gyeonggi-do (KR)

(72) Inventor: Andrei Popescu, Cambridge (GB)

(73) Assignee: Samsung Electronics Co., Ltd.

(21) Appl. No.: 14/601,756

(22) Filed: Jan. 21, 2015

(51) Int. Cl. G06F 11/07

(52) U.S. Cl. CPC G06F 11/0793; G06F 11/079; H04W 84/12

(57) ABSTRACT

A method for operating a wireless local area network (WLAN) is provided. The method includes transmitting at least one frame from an access point, receiving the at least one frame at a station (STA) located in the WLAN, determining if the received at least one frame includes an error, and, if it is determined that the received at least one frame includes an error, repairing the received at least one frame by restoring fields of the received at least one frame.

### BACKGROUND OF THE INVENTION

1. Field of the Invention

The present invention relates generally to a method and apparatus for wireless communication, and more particularly, to error correction in wireless local area networks (WLAN) frames received with incorrect frame check sequence (FCS).

2. Description of the Related Art

A dynamic host configuration protocol (DHCP) is a standardized networking protocol used on internet protocol (IP) networks for dynamically distributing network configuration parameters, such as IP addresses for interfaces and services. With DHCP, computers request IP addresses and networking parameters automatically from a DHCP server, thereby reducing the need for a network administrator or a user to configure these settings manually.

DHCP frames are used when setting up a WLAN connection. However, unreliable reception capabilities of the DHCP frames can slow down the WLAN connection or even cause the WLAN connection to fail altogether.

For example, WLAN connections are slowed as a result of an access point (AP) having to repeatedly transmit DHCP acknowledgement (ACK) frames and DHCP offer frames, as a result of a station (STA) failing to receive them correctly. As can be appreciated, this also overloads the WLAN medium with unnecessary transmissions, which, in turn, may saturate channels of the WLAN, which may then lead to errors in the transmitted DHCP frames.

When the aforementioned DHCP frames, e.g., DHCP ACK frames, are received at a WLAN station STA with one or more errors, such as errors associated with the payload, the WLAN station discards the received frames. For example, if the received DHCP frames do not verify FCS, such frames will be discarded, and the STA observes a time-out prior to initiating a new DHCP request transmission from the STA in an attempt to obtain WLAN network parameters, but such a process is very slow and can take tens of seconds.

Therefore, there exists a need for error correction in WLAN frames received with incorrect FCS.

### SUMMARY OF THE INVENTION

The present invention has been made to address the above problems and disadvantages, and to provide at least the advantages described below. Accordingly, an aspect of the present invention is to repair WLAN frames received with incorrect FCS based on prior knowledge of parts of a payload of these frames.

Another aspect of the present invention is to valiaate the repair of the WLAN frames against the FCS and/or another checksum present in the payload, such as the transmission control protocol (TCP) checksum and/or the user datagram protocol (UDP) checksum.

In accordance with an aspect of the present invention, a method for operating a WLAN is provided. The method includes transmitting at least one frame from an access point, receiving the at least one frame at a STA located in the WLAN, determining if the received at least one frame includes an error, and if it is determined that the received at least one frame includes an error, repairing the received at least one frame by restoring fields of the received at least one frame.

In accordance with another aspect of the present invention, a STA configured for use in a WLAN is provided. The STA includes at least one processor configured to receive at least one frame transmitted from an AP located within the WLAN, to determine if the received at least one frame includes an error, and, if it is determined that the received at least one frame includes an error, to repair the received at least one frame by restoring fields of the received at least one frame.

In accordance with another aspect of the present invention, a non-transitory computer-readable medium having stored thereon a plurality of executable instructions is provided. The plurality of instructions including instructions to transmit at least one frame from an access point, receive the at least one frame at a STA located in the WLAN, determine if the received at least one frame includes an error, and if it is determined that the received at least one frame includes an error, repair the received at least one frame by restoring fields of the received at least one frame.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a diagram illustrating a WLAN including an AP and a STA, according to an embodiment of the present invention;

FIG. 2A is a diagram of a screenshot illustrating a payload of a DHCP ACK frame, as received by the STA with errors, analyzed using MatLab® software;

FIG. 2B is a diagram of a screenshot illustrating the payload of the DHCP ACK frame illustrated in FIG. 2A, as picked up by a wireless sniffer located close to the AP and analyzed using Wireshark® software; and

FIG. 3 is a flowchart illustrating a method for operating a wireless network, according to an embodiment of the present invention.

### DETAILED DESCRIPTION OF EMBODIMENTS OF THE PRESENT INVENTION

Various embodiments of the present invention will now be described in detail with reference to the accompanying drawings. In the following description, specific details such as detailed configuration and components are merely provided to assist in the overall understanding of the embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

In accordance with the present invention, methods and apparatus are provided herein to recover frames, received by a WLAN station, that fail to verify FCS, by restoring payload fields that have fixed or predictable values and to validate such frame recovery by verifying IEEE 802.11 standard FCS or other payload checksum, such as the UDP checksum or TCP checksum.

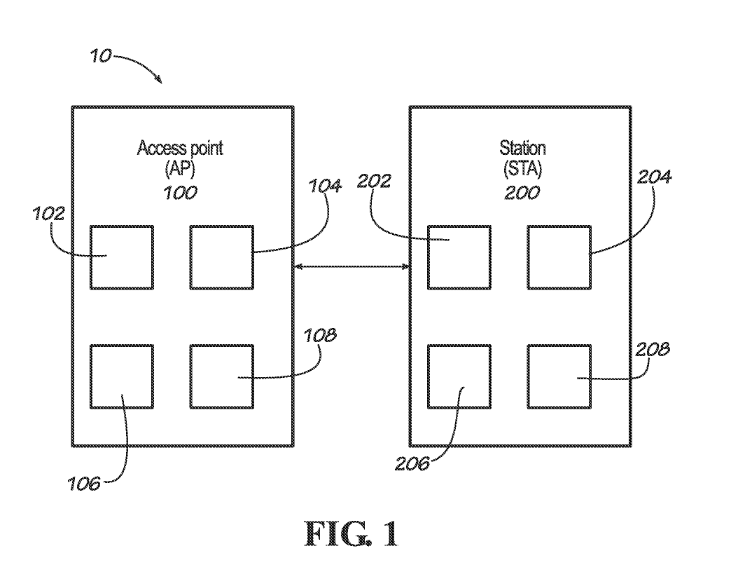

FIG. 1 illustrates a wireless communication network 10 (network 10), according to an embodiment of the present invention. The network 10 includes a plurality of STAs that are capable of communicating over the network 10. For illustrative purposes, the plurality of STAs is shown including a STA, e.g., an AP 100 (a D-link-825 access point) or base STA, and an individual user STA 200, e.g., a wireless device. The user STA 200 may be embodied in the form of a cell phone, a personal digital assistant (PDA), a laptop, a workstation, a personal computer, a video camcorder, etc. As can be appreciated, the user STA 200 can be embodied as another AP 100. Moreover, it is contemplated that the AP 100 can also be component of a larger system or device, rather than being a dedicated AP 100.

While the AP 100 will be described herein as a transmitting device and the user STA 200 as a receiving device, it will be understood by those skilled in the art that both the AP 100 and the user STA 200 can each receive and transmit signals over the network 10.

Moreover, it should be appreciated that the user STA 200 may be connected to other devices and/or networks in which the user STA 200 communicates. Further, although FIG. 1 only shows one user station and one AP within the network 10, it should be appreciated that the network 10 may include more than one user station and more than one AR

The network 10 can operate under one or more of the IEEE 802.11 standards such as the IEEE 802.11n, IEEE 802.11ac and IEEE 802.11a/b/g standards. Other IEEE 802.11 standards are also contemplated.

Continuing with reference to FIG. 1, an example of an embodiment of the components that may be provided in each of the AP 100 and user STA 200 in the network 10 is shown. As shown in FIG. 1, each of the AP 100 and user STA 200 is provided with at least one antenna (e.g., 102, 202), a receiving unit (e.g., 104, 204) a transmitting unit (e.g., 106, 206,) and at least one microprocessor (μp) (e.g., 108, 208). The components illustrated in FIG. 1 allow the AP 100 and user STA 200 to selectively transmit and receive frames within the network 10.

The μp 108 of the AP 100 controls the overall operation of the AP 100. In addition, the μp 108 is configured to initiate an operation of the wireless network. For example, the μp 108 may transmit one or more WLAN frames, e.g., a DHCP frame, over the network 10. After the frame is transmitted over the network 10, the μp 108 is configured to receive, from the receiving unit 104, a transmission from the user STA 200. It is noted that the microprocessor 208 associated with the user STA 200 operates similarly to the μp 108 of the AP 100.

The receiving unit 104 receives modulated frames over the network 10 and provides the modulated messages to the μp 108 for decoding. The transmitting unit 106 transmits one or more modulated frames provided by the μp 108 over the network 10, according to one or more transmitting protocols, e.g., Radio Layer Protocol (RLP). For example, the AP 100 transmits frames including, but not limited to, control frames, management frames, data frames, all of which may be provided in the physical (PHY) layer.

Certain received frames are especially important for establishing and maintaining a

WLAN connection. In particular, regarding the user STA 200, it is important for the user STA 200 to correctly receive one or more DHCP frames, e.g., DHCP ACK frame and DHCP offer frame, which may be part of a DHCP transaction initiated by the user STA 200 to obtain network parameters including an IP address from the AP 100.

In accordance with embodiments of the present invention, the aforementioned DHCP frames may be transmitted as broadcast/multicast frames from the AP 100 to the user STA 200. In other embodiments, the aforementioned DHCP frames may be transmitted as unicast frames from the AP 100 to the user STA 200. For purposes herein, as reception of the DHCP frames that are transmitted as broadcast/multicast frames is less reliable, i.e., in this instance there is no ACK mechanism to trigger their retransmission if the user STA 200 fails to receive the DHCP frames correctly, it is assumed that the DHCP frames are transmitted from the AP 100 as multicast frames.

The user STA 200 is configured to repair (or restore) DHCP frames that are received with errors. The errors may be caused by one or more factors including, but not limited to, a received signal carrying the DHCP frame that is weak, a received signal carrying the DHCP frame that was subject to frequency-selective fading, and a received signal carrying the DHCP frame that was corrupted by an interfering signal, e.g., an interfering signal that starts part-way through the DHCP frame.

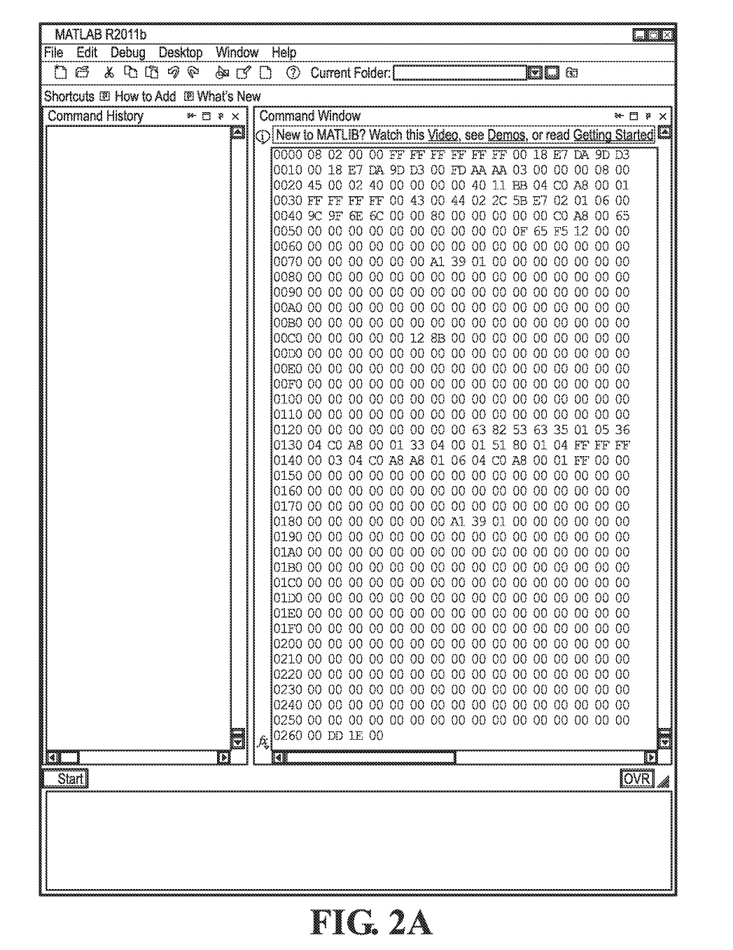

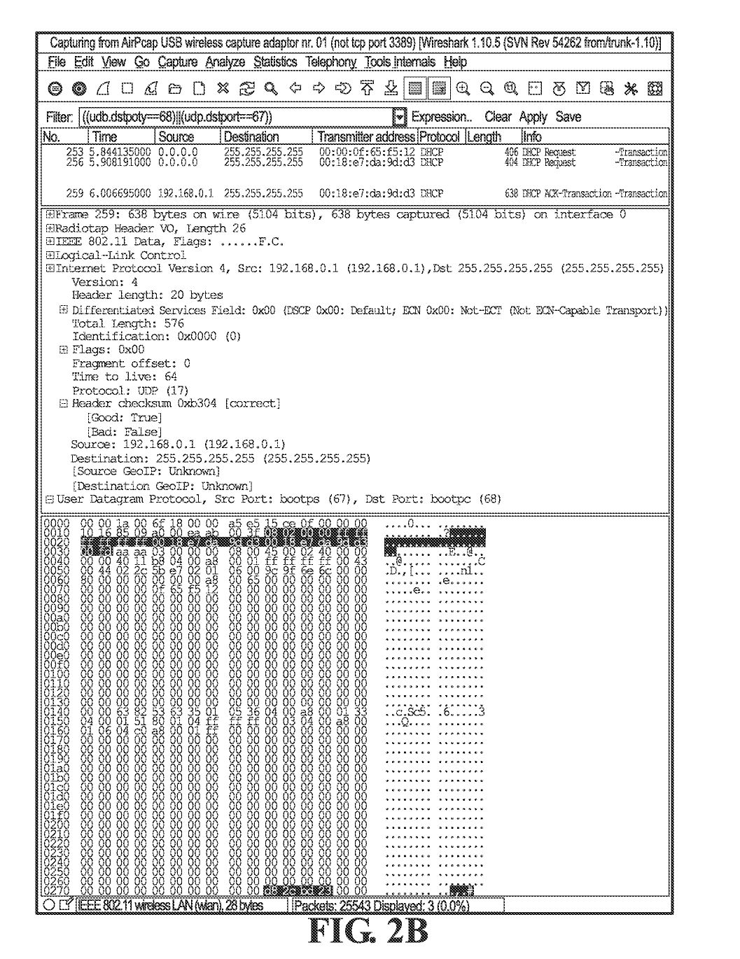

FIG. 2A is a diagram of a screenshot illustrating a payload of a DHCP ACK frame analyzed using MatLab® software, and FIG. 2B is a diagram of a screenshot illustrating the payload of the DHCP ACK frame shown in FIG. 2A analyzed using Wireshark® software.

The DHCP ACK frame may be transmitted by the AP 100 to the user STA 200 and, under certain conditions, may be received with errors. For illustrative purposes, the DHCP ACK frame's payload is shown with errors in the screenshot of FIG. 2A (analyzed using Matlab® software), as it was received by the STA's 200 WLAN PHY, and is shown without errors in the screenshot of FIG. 2B (analyzed using Wireshark® software), as it was received by another STA, e.g., embodied as a sniffer (not shown).

In accordance with embodiments of the present invention, having prior knowledge of, or the ability to predict, at least a part of the DHCP frame payload, the STAs 100 and 200 are configured to repair the errors to the DHCP frame caused by the above factors.

More particularly, as illustrated by the Wireshark® software of FIG. 2B, the useful DHCP ACK frame information is located in the middle of the payload, e.g., lines 0140-0160. From the Wireshark® software it is evident that there are all-zero fields before and after DHCP ACK frame information in the payload, e.g., lines 0060-0130 and lines 0170-0260. These fields may include padding as well as the boot protocol host file name and server file name (e.g., lines 0070-0140). In total, all-zero fields amount to 475 bytes of the 612-byte payload. Therefore, if the DHCP ACK frame contains a low number of errors, it can be assumed that the errors are located in the all-zero fields (see right side (Matlab®) of screenshot for example), so the frame can be repaired by setting zeros to these fields.

In accordance with the embodiments of the present invention, the repair of payload errors, as described above, can be performed when the data contained in the DHCP ACK frame is encrypted. In such an embodiment, the encryption of the payload may be accomplished by exclusive-or-ing (XOR-ing) the cleartext with a stream of pseudo-random bits generated based on an encryption key (a so-called “keystream”). Encryption schemes of this type are widely-used in WLANs such as advanced encryption standard-counter mode/cipher block chaining (CBC)-MAC protocol (AES-C/CMP), wired equivalent privacy (WEP) and temporal key integrity protocol (TKIP). When the data is encrypted, the repair is performed post-decryption.

When decrypting a DHCP ACK frame containing errors, since the message integrity check (MIC), if provided with the user STA 200, may fail, the user STA 200 performs the MIC check post-repair by inverting the polarity of bits in the encrypted payload of the DHCP ACK frame, in the bit positions corresponding to bits corrected post-decryption, followed by re-computing and checking the MIC. Alternatively, the corrected frame may be used without validating it with the MIC, if the associated risk is considered acceptable.

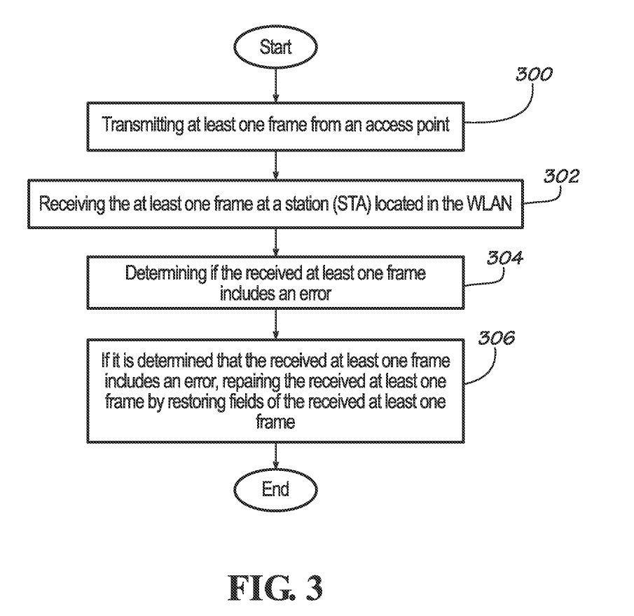

FIG. 3 is a flowchart illustrating a method for operating a wireless network, according to an embodiment of the present invention.

Referring to FIG. 3, the wireless network is assumed to be the WLAN 10 including the AP 100 and user STA 200.

At step 300, the transmitter 106 of the AP 100 generates a DCHP ACK frame and sends this frame to the μp 108 which transmits the DCHP ACK frame, which is received by the receiver 204 of the user STA 200, at step 302.

Thereafter, the receiver 204 sends the received DCHP ACK frame to the μp 208, which is programmed to determine if the received DCHP ACK frame includes an error, at step 304. More particularly, the μp 208 checks the payload, which includes fixed (or predictable) values. For example, as described above, the μp 208 is programmed to identify that the fields before (lines 0060-0130) and after (lines 0170-0260) the middle of the payload field (lines 0140-0160), of the received DCHP ACK frame, are predetermined to be zeros. Thus, if a non-zero value is detected in any of lines 0060-0130 and lines 0170-0260 by the μp 208, then it is assumed that an error has occurred during the transmission of the DCHP ACK frame, maybe as a result of weak signal strength, or as a result of interference.

If the μp 208 determines that the received DCHP ACK frame includes an error, the μp 208 is programmed to repair the received DCHP ACK frame by restoring the corrupted fields to all zeros, at step 306.

After the corrupted fields are restored to their correct values (zeros), the μp 208 verifies at least one of a FCS, a TCP checksum and UDP checksum.

Thereafter, the μp 208 sends a response to the transmitter 206, which then transmits the response to the AP 100. In the instance where a multicast DHCP ACK is received, the response is not an explicit/immediate ACK frame; rather the STA 200 implicitly responds according to preconfigured network parameters.

As can be appreciated, a quick and reliable establishment of a connection is important to provide a good user experience of the user STA 200. Providing the user STA 200 with the capability of repairing received frames that include errors, as described herein, improves connection reliability and speed, especially in an environment, e.g. in the presence of intense interference, that is likely to cause errors in received frames.

Frames other than the DHCP frames described herein, e.g., DHCP offer frames and DHCP ACK frames, may be repaired in a manner as described herein, as long as the receiving STA has prior knowledge of (or is able to predict) parts of the payload of the received frame. For example, in address resolution protocol (ARP) request frames the “Target MAC Address” may be expected to be zero and these frames may also contain zero padding at the end, which makes ARP request frames suitable for the aforementioned frame repair methods described herein.

The present invention and aspects thereof are capable of being distributed in the form of a non-transitory computer-readable program product stored in a tangible computer medium having stored thereon a plurality of executable instructions. The plurality of executable instructions may be in a variety of forms for execution on a processor, processors, or the like, and the present invention applies equally regardless of the particular type of signal-bearing media used to actually carry out the distribution.

The non-transitory computer readable program product can be in the form of microcode, programs, routines, and symbolic languages that provide a specific set or sets of ordered operations that control the functioning of the hardware and direct its operation, as known and understood by those skilled in the art. Examples of computer readable media include, but are not limited to: nonvolatile hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs. DVD-R/RWs, DVD+R /RWs, flash drives, memory sticks, HD-DVDs, mini disks, laser disks, Blu-ray disks, and other newer types of memories, and transmission type media such as digital and analog communication links.

The plurality of instructions comprise instructions to transmit at least one frame, e.g., a DHCP frame, from the AP 100, receive the at least one frame at the user STA 200 located in the WLAN 10, determine if the received at least one frame includes an error, and if it is determined that the received at least one frame includes an error, repair the received at least one frame by restoring fields of the received at least one frame.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for operating a wireless local area network (WLAN), the method comprising:
transmitting at least one frame from an access point (AP);
receiving the at least one frame at a station (STA) located in the WLAN;
determining if the received at least one frame includes an error; and
if it is determined that the received at least one frame includes an error, repairing the received at least one frame by restoring fields of the received at least one frame.

2. The method according to claim 1, wherein the restored fields have one of a fixed value and a predictable value.

3. The method according to claim 1, wherein determining if the received at least one frame includes the error comprises verifying at least one of frame check sequence (FCS), transmission control protocol (TCP) checksum and user datagram protocol (UDP) checksum.

4. The method according to claim 1, further comprising, after repairing the received at least one frame, re-verifying at least one of frame check sequence (FCS), transmission control protocol (TCP) checksum and user datagram protocol (UDP) checksum.

5. The method according to claim 1, wherein transmitting the at least one frame comprises transmitting a dynamic host configuration protocol (DHCP) acknowledgement (ACK) frame or a DHCP offer frame that are part of a DHCP transaction initiated in order to obtain network parameters including an internet protocol (IP) address.

6. The method according to claim 1, wherein transmitting the at least one frame comprises transmitting an address resolution protocol (ARP) request, and wherein the restored fields are part of a medium access control (MAC) address.

7. The method according to claim 1, wherein the at least one frame is transmitted as one of unicast frames, broadcast frames, and multicast frames.

8. The method according to claim 1, wherein the error is a result of at least one of a received signal carrying the at least one frame that is weak, a received signal carrying the at least one frame that was subject to frequency-selective fading, and a received signal carrying the at least one frame that was corrupted by an interfering signal that starts part-way through the at least one frame.

9. The method according to claim 1, wherein restoring fields of the received at least one frame comprises restoring fields to zero.

10. A station (STA) configured for use in a wireless local area network (WLAN), the STA comprising:
at least one processor configured to receive at least one frame transmitted from an access point (AP) located within the WLAN, to determine if the received at least one frame includes an error, and, if it is determined that the received at least one frame includes an error, to repair the received at least one frame by restoring fields of the received at least one frame.

11. The STA according to claim 10, wherein the restored fields have one of a fixed value and a predictable value.

12. The STA according to claim 10, wherein, if it is determined that the received at least one frame includes the error, the at least one processor is further configured to verify at least one of frame check sequence (FCS), transmission control protocol (TCP) checksum and user datagram protocol (UDP) checksum.

13. The STA according to claim 10, wherein, after repairing the received at least one frame, the at least one processor is further configured to re-verify at least one of frame check sequence (FCS), transmission control protocol (TCP) checksum and user datagram protocol (UDP) checksum.

14. The STA according to claim 10, wherein the received at least one frame is one of a dynamic host configuration protocol (DHCP) acknowledgement (ACK) frame and a DHCP offer frame that are part of a DHCP transaction initiated in order to obtain network parameters including an internet protocol (IP) address.

15. The STA according to claim 10, wherein transmitting the at least one frame comprises transmitting an address resolution protocol (ARP) request, and wherein the restored fields are part of a media access control (MAC) address.

16. The STA according to claim 10, wherein the at least one frame is transmitted as one of unicast frames, broadcast frames, and multicast frames.

17. The STA according to claim 10, wherein the error is a result of at least one of a received signal carrying the at least one frame that is weak, a received signal carrying the at least one frame that was subject to frequency-selective fading, and a received signal carrying the at least one frame that was corrupted by an interfering signal that starts part-way through the at least one frame.

18. The STA according to claim 10, wherein the at least one processor is further configured to restore the fields of the received at least one frame to zero.

19. A non-transitory computer-readable medium having stored thereon a plurality of executable instructions, the plurality of instructions comprising instructions to:
transmit at least one frame from an access point (AP);
receive the at least one frame at a station (STA) located in the WLAN;
determine if the received at least one frame includes an error; and
if it is determined that the received at least one frame includes an error, repair the received at least one frame by restoring fields of the received at least one frame.
